(19) United States
(12) Patent Application Publication
(10) Pub. No.: US 2009/0267319 A1
(43) Pub. Date: Oct. 29, 2009

(54) DEVICE FOR PULLING BICYCLE OR TRICYCLE

(75) Inventor: Elaine Margaret Munro Armstrong, West Sussex (GB)

Correspondence Address: Fay Sharpe LLP, 1228 Euclid Avenue, 5th Floor, The Halle Building, Cleveland, OH, 44115, US

(73) Assignee: Bernard Paul ARMSTRONG, Slinfold (GB)

(21) Appl. No.: 12/304,419

(22) PCT Filed: Jun. 13, 2007
(86) PCT No.: PCT/IB2007/052242

§ 371 Date: Dec. 11, 2008

(30) Foreign Application Priority Data
Jun. 14, 2006 (GB) 0611729.5

(51) Int. Cl. B60P 3/06

(52) U.S. Cl. 280/402

(57) ABSTRACT

A device to facilitate the pulling of a child's cycle (8) (especially when fitted with stabiliser wheels (9) comprises a substantially horizontal wheeled platform (1) preferably a substantially triangular three-wheeled platform incorporating a slot (5) or other means for holding the front wheel (10) of the child's cycle in a substantially vertical orientation and raised a short distance above the ground, with a rigid or flexible handle (11) for pulling said device while walking or means for securing such a handle thereto. This device enables a child's bicycle or tricycle to be safely and conveniently be towed by an adult even with a child sitting on the cycle while the adult can also hold a child and/or push a perambulator. The device is compact and portable and may readily be carried by hand, back-pack or shoulder strap when not in use, such as when the child is cycling freely.

The present invention relates to a device to facilitate the pulling of a child's bicycle or tricycle, while maintaining it upright, optionally with a child seated on the cycle.

Devices are already available to facilitate the transportation of two children when using a perambulator consisting of a wheeled standing board connected to the lower rear part of the perambulator, such that an older child may stand on the standing board while a younger child lies or sits in the perambulator. PCT Patent Publication No. WO 93/22179 describes a connecting device for securing such a standing board to the perambulator.

Another requirement that can arise when a parent or other adult is walking with small children is the need to include a child's cycle (which may be a bicycle or tricycle) in the walking group. This may involve the need for a child to be seated on the cycle while the adult pulls it (for example, because it is not safe for the child to cycle freely, or because the child is tired); or the child may want to walk alongside the adult holding the adult's hand, while the adult pulls the cycle with the other hand; or the adult may be pulling the cycle while walking to meet the child from school or another activity, so that the child can ride the cycle home. Any of these situations may also include one or more additional children either walking or in a perambulator. In all of these situations, it can prove tricky for the adult to hold and pull the cycle securely while also holding onto and watching over the accompanying children, and possibly also pushing a perambulator or similar.

The device of the present invention assists in securing and pulling the cycle in such situations, while leaving the adult freer to hold and watch the accompanying children. Any such device should also desirably be readily portable so that it can easily be carried by the adult when not in use because the child is cycling freely; moreover, the device should preferably be able to be carried while leaving the adult's hands free to hold other children or carry other items.

A number of single-axle, two-wheeled trailers have previously been proposed for the purpose of towing one bicycle by another bicycle (see, for example, U.S. Pat. No. 5,454,578 (Neack, published 3 Oct. 1995), DE 101 06 878 C1 (Brenneken, published 29 May 2002), and DE 201 12 149 U1 (Krammer, published 22 Nov. 2001). All of those trailers are substantial and non-portable devices designed to ensure that the towed bicycle is very firmly secured to the trailer. Their lack of portability and their two-wheeled construction renders them unsuitable for the present purpose.

A transporting assembly for manually maneuvering a motorcycle is described in US 2002/0119035 (Hamilton, published 29 Aug. 2002). That is a complex and non-portable construction wholly unsuited for use with a child's cycle.

The present invention now provides a device to facilitate the pulling of a child's bicycle or tricycle, comprising a substantially horizontal wheeled platform incorporating means for holding the front wheel of a child's bicycle or tricycle in a substantially vertical orientation and raised a short distance above the ground, and comprising a handle for pulling said device while walking or means for securing such a handle thereto.

The invention will now be described in more detail with reference to the accompanying drawings, which illustrate one embodiment of the device according to the present invention, and in which

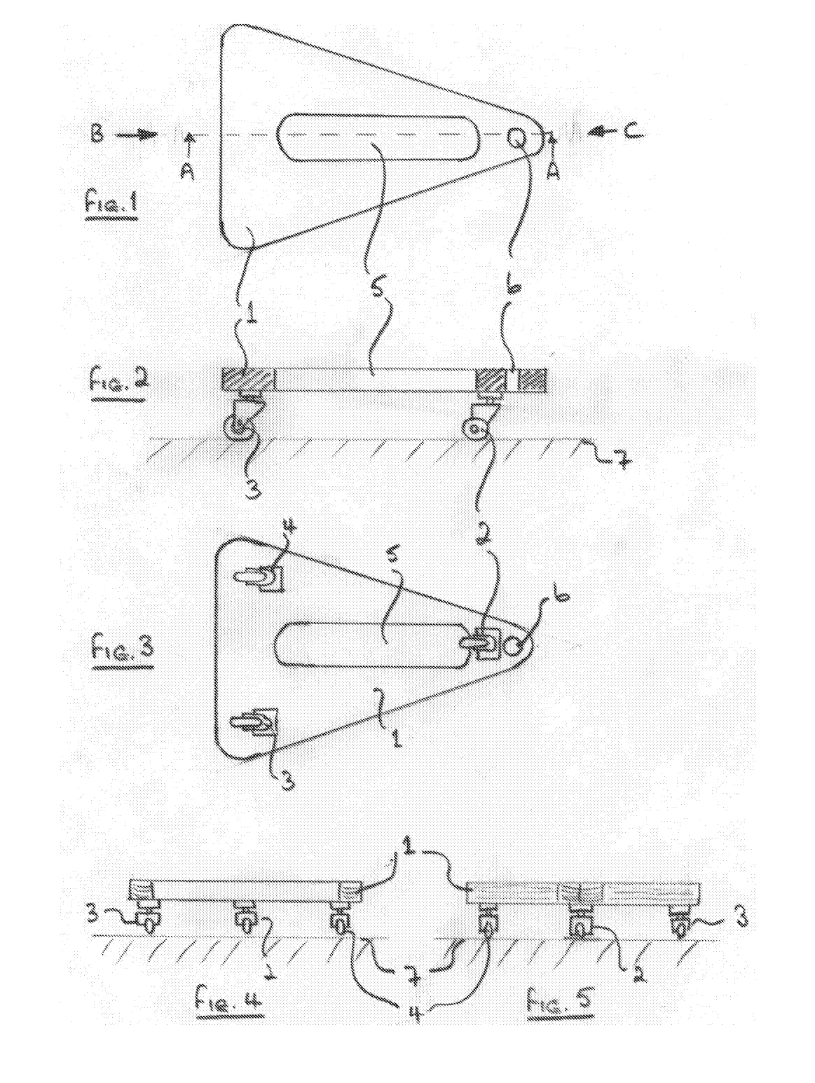

FIG. 1 is a view from above of one embodiment of the device according to the present invention;

FIG. 2 shows a cross-section of the embodiment along the line A-A in the direction shown by the arrows marked in FIG. 1;

FIG. 3 is an underneath view of the embodiment shown in FIG. 1;

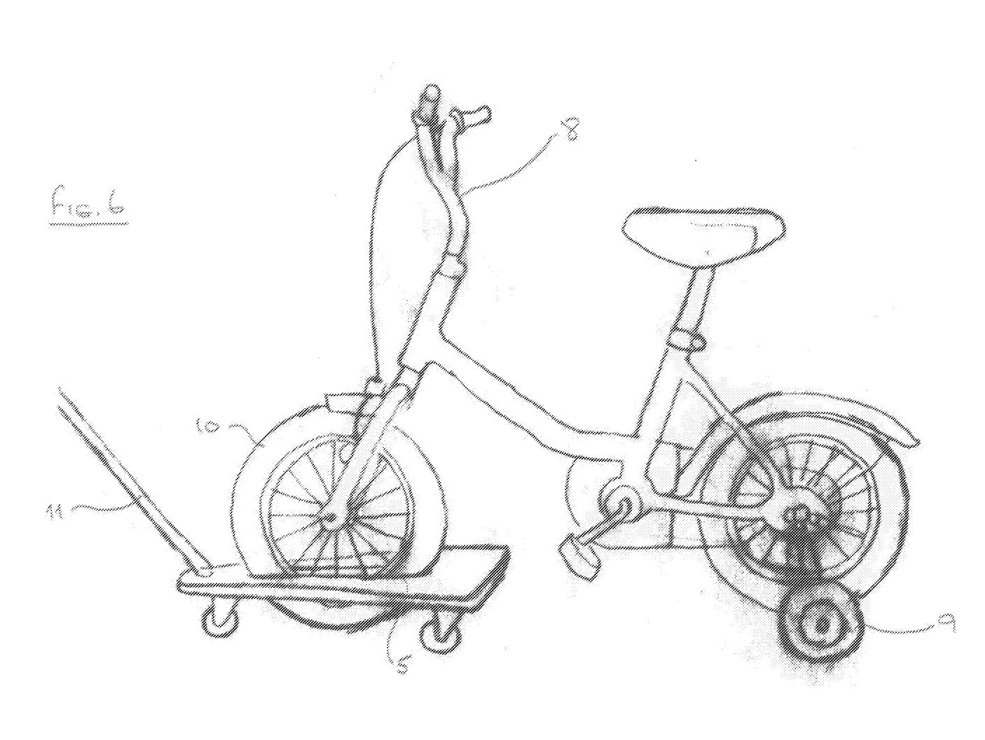

FIG. 4 is an end view of the embodiment in the direction of the arrow B marked in FIG. 1;

FIG. 5 is an end view of the embodiment in the direction of the arrow C marked in FIG. 1; and

FIG. 6 is a perspective view of the device while being used to accommodate a bicycle.

The device comprises a substantially horizontal platform 1, provided with three wheels 2, 3, 4 on its underside. A slot 5 in the platform 1 is sized so as to accommodate the lower part of the front wheel of a child's bicycle. A hole 6 provides a means for securing a rope handle by which the device may be pulled while the adult user is walking.

In this embodiment, the platform 1 is substantially isosceles triangular, with three wheels 2, 3, 4. An isosceles triangular shape for the platform 1 can provide an optimal combination of stability and compactness of the device. The isosceles triangular shape has two longer sides and a shorter base: in use, the apex between the two longer sides is the front of the device and the shorter base is the rear of the device. Likewise, the use of three wheels 2, 3, 4 on the device can provide an optimal combination of stability, compactness and maneuverability. The shape of the device is, however, not critical to the invention, and the platform could, for example, be rectangular or circular without detracting from its functionality. Normally, the device would be designed to be as compact as possible commensurate with providing sufficient stability, especially when securing a bicycle. Compactness is desirable for storage and transport. The device should not, or course, be so long as to interfere with either the rear wheel or the pedals of the bicycle at its rear end, nor with the person(s) walking and pulling the device at its front end. Suitably, the length of the device should not exceed about 600 mm, nor the width exceed about 450 mm. In the embodiment shown, the platform 1 has a maximum length of 400 to 450 mm, with a maximum width of about 300 mm.

The platform 1 may be of a variety of materials, for example wood, metal, plastics (especially injection-moulded plastics), fibreglass, or another light-weight but rigid material.

Platform 1 includes a slot 5 sized so as to accommodate the lower part of the front wheel of a child's cycle. This constitutes the means for holding the front wheel of a child's cycle (especially a bicycle) in a substantially vertical orientation and raised a short distance above the ground. The width of slot 5 is such that part of the circumference of the wheel of a child's cycle can readily be placed into and removed from the slot, with no substantial resistance but with little lateral leeway, such that the wheel is accommodated fairly snugly within the slot. The length of the slot 5 is such that when part of the circumference of the wheel of a child's cycle is placed into the slot to the full extent possible, with the wheels of the device resting on the ground as shown in FIGS. 2, 4 & 5, then the wheel of the cycle will not be touching the ground. In other words, the height of the platform 5 above the ground slightly exceeds the depth of the segment of the wheel protruding through the platform. In the embodiment shown, the width of the slot 5 is approximately 60 mm, and its maximum length is about 240 mm; the height of the top of the platform 1 from the ground is about 80 to 85 mm with wheels 2, 3, 4 of about 50 mm diameter, or about 100 mm above ground with wheels 2, 3, 4 of about 75 mm diameter. This is suitable for a cycle wheel external diameter (i.e. including the tyre) within the range of about 25 to 35 cm (from 10 to 14 inches).

Children's bicycles typically have wheel diameters of from 25 cm, more commonly from 30 cm, up to 40 cm (from 10 inches, more commonly from 12 inches, up to 16 inches), but the present device would more usually be used with bicycles for younger children, and typically with wheel diameters of up to 35 cm (up to 14 inches). Children's tricycles typically have wheel diameters of up to 25 cm (up to 10 inches).

For a given cycle wheel size, there is a relationship between the length of the slot accommodating the wheel and the height of the platform above the ground, in that the greater the platform height above the ground, the larger the segment of the wheel that can be accommodated within and below the device, and thus reducing the risk of the wheel becoming dislodged from the device. On the other hand, increase in the platform height, necessarily increases the size of the device and decreases its compactness and portability.

In order to facilitate use of the device with cycles of different wheel sizes, the slot 5 may be of adjustable length. This could be achieved, for example, by providing one or more moveable (or removable) lugs or stops along the length of the slot or other holding means. Such lugs or stops may be slideable or may have multiple discrete fixing locations, effectively adjusting the length of the slot or other holding means available for securing the wheel.

Preferably, the cycle wheel should be secured such that its lowest point is at least 5 mm, more preferably at least 10 mm, above the ground, so as to avoid risk of the bicycle wheel hitting raised patches of ground. In order to avoid problems of the wheel hitting the ground when the device is pulled up or down a kerb or used on rough ground, typically the ground clearance should be in the region of 25 to 50 mm. Conversely, too great a ground clearance would cause the front of the cycle to become inclined upwards and would decrease stability of the bicycle. To that end, the ground clearance should not normally exceed 200-300 mm, and preferably be less than 100 mm.

Additionally, the distance between the rear of the slot 5 (or other means for securing the wheel of the cycle) and the rear edge of the platform 1 should preferably be kept to a minimum commensurate with stability so as not to interfere with rotation of the pedals of the cycle and the child's feet thereon. This distance should normally not exceed 100 mm, and preferably be less than 50 mm, especially when used with smaller cycles. With children's tricycles, the pedals are often attached directly to the front-wheel axis and hence, with the front wheel of the tricycle located in the slot 5, the pedals will be raised above the platform 1, will not be rotating as the wheel will be off the ground, and will not interfere with the platform especially when they are in a near-horizontal position.

In the embodiment shown, the platform 1 has a thickness of 15 to 20 mm, and thus the slot 5 has a similar depth. It is this depth of the slot, combined with little lateral leeway between the width of the wheel and the sides of the slot, that serves to secure the wheel—and hence the bicycle—in a substantially vertical orientation. This constitutes a simple and efficient method of holding the wheel in the necessary orientation, but this is not the only method of holding the wheel. If, for example, the platform were of substantially less thickness, as could be the case with a platform made of metal or of a rigid plastics material, then the slot could be provided with upstanding and/or downstanding flanges or lugs along its sides, in order to provide the required means for holding the front wheel of a child's bicycle in a substantially vertical orientation. Such flanges or lugs could be adjustable to accommodate different sizes of wheels: different wheel thicknesses and/or different wheel diameters.

The means for holding the wheel could alternatively be provided by a flat or arc-shaped grooved member for receiving the lower part of the cycle wheel and situated on top of or through, and along the centre line of, the platform.

For additional safety, one or more straps, rods or the like is desirably provided for securing the wheel to the device, especially if a child is seated on the cycle. Such straps or rods could pass over or, preferably, through the front wheel of the cycle so as to prevent it from unintentionally becoming dislodged from the device. For example, in the embodiment shown in the drawings, a security strap may be affixed on one side of the slot 5 such that it can be passed through or around the front wheel or other part of the cycle, with the other end of the strap being detachably secured on the other side of the slot, thus securing the cycle to the device. Security straps may alternatively or additionally be provided along the length of the device. Any such straps should preferably be of adjustable length. Straps of nylon or similar material, adjustably fitted with one or more buckles or clips, are suitable for this purpose.

The device is primarily intended for use with a child's bicycle that is fitted with rear stabiliser wheels either side of the main rear wheel to prevent the bicycle from toppling sideways (see FIG. 6), or with a tricycle. The device can be used with a bicycle without stabiliser wheels, but the adult user would need to be aware that the overall assembly (device and bicycle) would be less stable, especially if a child were sitting on the bicycle. This could be counteracted to some extent by having a wider wheelbase on the device. It is, however, generally when the child is of such an age or experience that he/she is using a bicycle with stabiliser wheels or a tricycle that need arises for the adult to tow a bicycle or tricycle.

When the device is being used with a bicycle with stabiliser wheels or with a tricycle, the snugness of the fit of the front wheel of the cycle within the slot 5 (or other means for holding the wheel substantially upright) is less critical than when used with a bicycle without stabiliser wheels. This is because the pair of stabiliser wheels or rear tricycle wheels assist in maintaining the cycle upright and hence a little slack in the fit of the front wheel within the device can be tolerated, whereas with a standard bicycle (without stabiliser wheels) a more snug fit, with less sideways leeway, is desirable in order to maintain the assembly in a stable manner.

The device according to the invention also comprises a handle for pulling the device while walking or means for securing such a handle thereto. In the embodiment shown in the drawings, this is provided simply as a hole 6 in the platform 1 through which a rope, cord or strap may be tied to constitute the handle. This provides a simple, compact and easily adjustable handle for the device. Thus the means for securing a handle may simply be a hole, hook, eye or similar to which a length of rope or cord may be secured, for example simply by looping the rope, cord or strap through the hole, hook or eye, or by use of a clip (such as a spring clip). In a preferred embodiment, the device is provided with a rigid handle (for example of metal or plastics) in order that the adult pulling the device has more control over its movement, and hence over the safety of any child sitting on the cycle. Such a rigid handle may be secured permanently to the device or may be detachable, and potentially interchangeable with a rope-type handle. It may also be telescopic, for obvious reasons of compactness and storage.

It has been found that a flexible handle, such as a rope, cord or strap, is often adequate when the device is being used on fairly level ground. This can also be easier for the accompanying adult to hold when also having to hold onto other children or carry other items. When the device is being used on a down-hill slope, however, a more rigid handle is preferred to provide more control and prevent the device from running away down hill. A more rigid handle with a hand-grip or similar can also be preferred when the adult is additionally pushing a child's buggy, perambulator or other wheeled apparatus.

One way of providing a multi-purpose handle is to have a flexible handle, such as a rope or similar, passing through a removable rigid or semi-rigid sleeve. With the sleeve in place, the handle will be rigid or semi-rigid, and with the sleeve removed the handle will be flexible.

The wheels 2, 3 4 of the illustrated embodiment are simple castor-type wheels. The device would normally have 3 or 4 wheels, but the number of wheels is not critical provided that the device has the necessary stability to maintain the bicycle in a substantially upright position. The preferred number of wheels is generally 3, to provide an optimum combination of stability and maneuverability. All the wheels may be fully rotatable through 360 degrees about a vertical axis, but this can result in the device being somewhat too maneuverable and insufficiently controllable by the accompanying adult. To that end, it is preferred that, in a three-wheeled device, the single wheel should be pivotable but that the other two wheels should be fixed.

Although the wheels may be provided with a suspension system, this is not generally necessary when the device is intended to be used simply for pulling a cycle. Even if a child were sitting on the cycle when pulled, the rear end of the cycle on which the child is seated may have its own suspension system and in any case would not be directly above the device. It is envisaged that the device will normally be used for pulling cycles along a hard-surfaced road, path or similar and, as such, the device may have only small wheels, of, for example 40 to 50 mm diameter. The use of small wheels also keeps the size of the device compact. Larger wheels of up to, for example, 100 mm, or even 150 mm, diameter may, however, be incorporated in the device, especially if it is designed to be used over rough ground. Larger wheels can also improve performance when the device is pulled up or down a kerb. A preferred wheel size is from 50 to 100 mm diameter.

In FIG. 6, a child's bicycle 8, which is fitted with stabiliser wheels 9, has its front wheel 10 located within the slot 5 of the device, with the front wheel 10 raised slightly above the ground. The device is fitted with a rigid handle 11 by which it may be pulled.

Using an assembly of the type shown in FIG. 6, the device—and thus also the child's cycle—can safely and conveniently be pulled by an adult, while the adult can also hold a child and/or push a perambulator. Optionally, a child may be sitting on the cycle being towed.

The device of the present invention can be compact, light-weight and readily portable. This enables it to be carried easily by the adult when not in use, such as when the child is cycling freely. Moreover, the device can be made sufficiently compact to be carried in a back-pack or slung over a shoulder, thus leaving the adult's hands free to hold children or carry other items. To that end, the device may optionally include a detachable carrying strap. If the device includes a flexible handle, particularly one in the form of a rope, cord or strap, that handle may also serve as a carrying strap, there being means to affix it to a second location on the device so as to form a loop. As a further option, depending on their configuration, any security strap or straps provided for securing the cycle's front wheel to the device may, when the device is not in use, be configured as a carrying strap or straps.

Although the present device has been described primarily with reference to use in conjunction with a child's bicycle, the device could equally satisfactorily be used with a child's tricycle, the only difference being that tricycles usually have smaller wheels and therefore the device itself could be smaller. It would, of course, be necessary for the device to securely hold the smaller wheel of a tricycle, either by having a smaller slot or other receptacle for the wheel or by including suitable adjustment permitting the securing of different sized wheels.

Child's tricycles now frequently have a rear-protruding handle to provide some control to an accompanying adult. Specifically, however, such a rear handle does not provide any control over the steering of the tricycle: the child on the tricycle can usually steer the tricycle independently of the adult. The adult can steer the tricycle (with or without a child sitting on it) only by pushing down on the handle to lift the tricycle's front wheel off the ground, which is far from convenient. The device of the present invention, on the other hand,—particularly when fitted with a rigid handle—enables an adult to control the tricycle from the front, instead of from the rear. This provides more control to the adult, and also enables the tricycle to be pulled in a forward-facing direction and with control over the steering.

A bicycle or tricycle can be placed in and secured to the present device—and also be detached and removed—simply and quickly. The device is also of simple construction and hence can be manufactured fairly cheaply.

1. A device to facilitate the pulling of a child's cycle, comprising a substantially horizontal wheeled platform incorporating means for holding the front wheel of a child's cycle in a substantially vertical orientation and raised a short distance above the ground, and comprising a handle for pulling said device while walking or means for securing such a handle thereto.

2. A device as claimed in claim 1, wherein the platform is of substantially isosceles triangular shape.

3. A device as claimed in claim 1, having three wheels.

4. A device as claimed in claim 3, wherein one wheel is freely pivotable about a vertical axis and two wheels are fixed.

5. A device as claimed in claim 1, wherein the means for holding the cycle wheel is a slot within the platform the slot being sized so as to accommodate said wheel and hold it in a substantially vertical orientation.

6. A device as claimed in claim 1, wherein the means for holding the cycle wheel is adjustable to accommodate different wheel sizes.

7. A device as claimed in claim 1, additionally comprising means for securing the wheel to the device.

8. A device as claimed in claim 7, wherein the means for securing the wheel is a strap that can be passed over or through the wheel of the cycle.

9. A device as claimed in claim 1, which includes a carrying strap.

10. A device as claimed in claim 2, having three wheels.

11. A device as claimed in claim 10, wherein one wheel is freely pivotable about a vertical axis and two wheels are fixed.

12. A device as claimed in claim 11, wherein the means for holding the cycle is a slot within the platform, the slot being sized so as to accommodate said wheel and hold it in a substantially vertical orientation.

13. A device as claimed in claim 11, wherein the means for holding the cycle wheel is adjustable to accommodate different wheel sizes.

14. A device as claimed in claim 11, additionally comprising means for securing the wheel to the device.

15. A device as claimed in claim 11, which includes a carrying strip.

16. A device as claimed in claim 2, wherein the means for holding the cycle wheel is a slot within the platform being sized so as to accommodate the wheel and hold it in a substantially vertical orientation.

17. A device as claimed in claim 3, wherein the means for holding the cycle wheel is a slot within the platform being sized so as to accommodate the wheel and hold it in a substantially vertical orientation.

18. A device as claimed in claim 4, wherein the means for holding the cycle wheel is a slot within the platform being sized so as to accommodate the wheel and hold it in a substantially vertical orientation.

19. A device as claimed in claim 2, wherein the means for holding the cycle is adjustable to accommodate different wheel sizes.

20. A device as claimed in claim 3, wherein the means for holding the cycle is adjustable to accommodate different wheel sizes.
